(19) United States
(12) Patent Application Publication
(10) Pub. No.: US 2025/0315295 A1
(43) Pub. Date: Oct. 9, 2025

(54) eBPF GENERAL ALLOCATOR

(71) Applicant: Crowdstrike, Inc., Sunnyvale, CA (US)

(72) Inventors: Justin Deschamp, Orléans (CA); Martin Kelly, Bothell, WA (US); Oscar Lim, Irvine, CA (US); Marco Vedovati, Albino (IT)

(21) Appl. No.: 18/630,667

(22) Filed: Apr. 9, 2024

(51) Int. Cl. G06F 9/50

(52) U.S. Cl. CPC G06F 9/5016

(57) ABSTRACT

Systems and methods for an eBPF general allocator for an eBPF program is provided. The method includes receiving, by a first eBPF program, a first entry based on an atomic operation. The first entry is from a number of entries in a free list that indicates available space in a buffer. The available space is indexed by the number of entries in the free list. The method further includes identifying, based on the first entry, a pointer to the buffer. The pointer is associated with an allocation of the available space in the buffer based on the first entry. The allocation of the available space is to the first eBPF program. The method further includes executing, by a processing device, the first eBPF program with exclusive access to the allocation of the available space in the buffer during an execution instance of the first eBPF program.

### TECHNICAL FIELD

Aspects of the present disclosure relate to extended Berkeley packet filter (eBPF) programs, and more particularly, to a general memory allocator for eBPF programs.

### BACKGROUND

A Berkeley packet filter (BPF) allows a set of rules to be defined for filtering network packets at a low level. For example, BPF provides a raw interface to network packets for specifying filtering criteria based on various packet attributes, such as source addresses, destination address, protocol type, port number, etc. The set of defined rules can be used to capture, drop, and/or modify packets in real time.

An extended Berkeley packet filter (eBPF) is different from the classic BPF in that eBPF allows for more complex and versatile packet processing as well as general purpose in-kernel programmability. For example, eBPF programs may be implemented for execution of custom programs within a kernel without needing to add additional modules or modifying the kernel source code. Although an eBPF program may use a 512-byte stack, it is still useful (although not always necessary) for an eBPF program to have a memory allocation for storing instructions and data of the eBPF program. However, there is currently no straightforward way to dynamically allocate the memory or create a general allocator for the eBPF program entirely within eBPF code.

In infrastructures such as eBPF, where code is provided into the kernel space of an operating system to execute, several security features may be present. The security features may cause the code that is to be run in the kernel space to be limited in the types of access the code is allowed. For example, the code that is to be run in the kernel space may be denied access to certain functionality or limited to access of functions that are less likely to represent a risk to the kernel space. As an example, code provided to eBPF may be unable to access certain locks or may only have access to atomic operation (e.g., atomic increment/decrement) that do not return an incremented/decremented value from the atomic operation. Thus, the eBPF program may not have access to fully-functional atomic operations.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for dynamic memory allocation using an eBPF general allocator.

FIG. 2 illustrates tables associated with kernel preemption being disabled and enabled.

FIG. 3 is a flow diagram of a method for dynamic memory allocation.

FIG. 4 is a component diagram of an example of a device architecture for an eBPF general memory allocator.

FIG. 5 is a block diagram of an example computing device that may perform one or more of the operations described herein, in accordance with some embodiments of the disclosure.

### DETAILED DESCRIPTION

An eBPF memory allocation may be attempted in some cases based on per-central processing unit (CPU) array maps and an assumption that the eBPF program will not be preempted (i.e., halted) by another eBPF program during an execution instance of the eBPF program. That is, once execution of the eBPF program begins, it will not be stopped before the execution has completed. However, some Linux kernels are configured to allow eBPF programs to be preempted. In such environments, there is no guarantee that an eBPF program will run to completion without being preempted by another eBPF program. When an eBPF program is preempted, execution of the eBPF program is halted so that the resources the eBPF program was using can be made available for other operations. Thus, there is a need for techniques that guarantee no other eBPF programs can interfere with and/or corrupt the data of an eBPF program during runtime of the eBPF program.

The techniques associated with per-CPU array maps are not equally applicable on kernels that include additional preemption points (e.g., some Linux kernel versions are configured with CONFIG_PREEMPT=y). That is, a first eBPF program executing on such kernels can be preempted to allow a second eBPF program to execute on the same CPU and provide a scenario where two eBPF programs have access to the same per-CPU array map at the same time. Accordingly, the exclusivity of the per-CPU array map to a particular eBPF program may be lost in such cases, causing per-CPU techniques to become ineffective on these kernels.

eBPF technology utilizes a data structure that allows for sharing of data between the kernel on which the eBPF runs and a user space. For example, data may be shared in association with ring buffers, tries, hash maps, and/or arrays. The data structure may also be used to provide additional memory space for execution of the eBPF program. However, the data structure alone does not provide a straightforward way for eBPF programs to have memory buffers exclusive to a given eBPF program on preemptive kernels. Thus, not only do previously implemented techniques not allow eBPF programs to allocate memory dynamically, only certain (older) kernel versions disable preemption during eBPF program execution, meaning that a given eBPF program must run to completion on the same CPU without being interrupted by another eBPF program on the same CPU.

Examples of the present disclosure address the above-noted and other deficiencies by using eBPF maps to build a general memory allocator. A combination of eBPF stacks or queues and array maps is used to build the general allocator and provide exclusive access to a memory buffer for the duration of eBPF program execution. An array map is created with N entries of size S bytes. A stack/queue map is generated with the N entries, initialized with the following values: {0, 1, . . . , N−2, N−1}. An entry from the stack/queue is popped for the allocation, such that a returned number X represents an index to a free buffer in the array map. A pointer to the buffer is retrieved at index X from the array map for the running program to have exclusive access to the S-sized buffer for the duration of the runtime of the program.

After the program has finished running, the index X is pushed back to the stack/queue. A second program may subsequently pop and may reuse the buffer index X freed from the first program. The use of the stack or queue provides an atomic way to obtain and release/free the buffer indices. The lack of atomic BPF instructions in older eBPF versions results in these techniques being an important part of implementing general memory allocations.

As discussed herein, the present disclosure provides an approach that improves the operation of a computer system by providing a way to dynamically allocate memory for eBPF program execution based on a general memory allocator. As a result, memory can be efficiently allocated to eBPF programs in a fine grained manner.

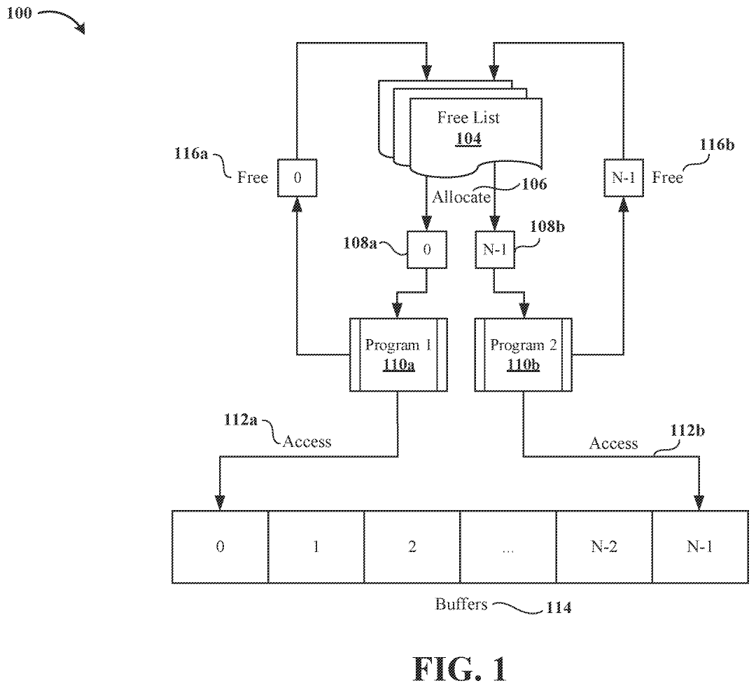

FIG. 1 is a block diagram that illustrates an example system 100 for dynamic memory allocation using a BPF general allocator (e.g., for an eBPF program). The allocator is associated with two features (e.g., a stack/queue and a flat array) that provide the ability for the system 100 to perform general memory allocations. The stack/queue includes a number of free/available indices N on a free list 104. In an example, if 100 buffers 114 are desired for general allocations, the stack or queue of N free indices would be populated with the numbers 0 to 99, representing the free/available indices on the free list 104 for allocations.

The number of buffers 114 for allocations may be based on heuristic testing. For example, a heuristic may indicate that only a certain number of buffers 114 is needed to prevent collisions and/or failed allocations. While 100 buffers may be a suitable number of buffers 114 in some examples, it should be appreciated from the diagram of the example system 100 that any number of buffers 114 may be implemented. One parameter for determining the number of buffers 114 corresponds to how many CPUs there are in the systems. In some examples, the number of CPUs is multiplied by 5 or 6 to determine the total number of buffers 114.

The flat array includes N fixed-sized entries that are indexed by the numerical values 0 through N−1 included in the stack/queue. That is, the flat array is associated with buffers 114 that correspond to entries in the free list 104. The general allocator including the stack/queue and the flat array is implemented together with algorithms used for initializations, allocations, and freeing of objects to the free list 104.

To perform an initialization procedure, an array map of size S bytes is created using the N entries. A stack/queue map is filled with the N entries. That is, the free list 104 is populated with entries from 0 to one less than the number of buffers 114 that are being used for the allocation. Hence, upon initialization, the free list 104 is populated from 0 to N−1 in the following manner: {0, 1, 2, . . . , N−2, N−1}.

For an allocation procedure 106, an entry 108 is popped from the free list 104 stack/queue. For example, program 1 110a may pop a first entry 108a from the free list 104. If the first entry 108a corresponds to value 0, then program 1 110a would perform an access procedure 112a that refers to/accesses buffer 0. If program 1 110a received a different value from the free list 104 via the allocation procedure 106, then program 1 110a would refer to/access a different buffer value of the buffers 114.

In an example, the free list 104 may include 4 values at a particular time instance. For instance, the free list 104 may include values 0, 1, 2, and 3. If the popping operation for the allocation procedure 106 is performed in order of arrival, the first free entry 116a-116b that arrives in the free list 104 will be popped first. Thus, if value 0 is the first/oldest free entry 116a to be pushed onto the free list 104, then value 0 is the first value to be popped from the free list 104 during the allocation procedure 106. Program 1 110a accesses 112a buffer 0 until program 1 110a has finished executing. Afterwards, program 1 110a will push value 0 as a free entry 116a back onto the free list 104, so that value 0 becomes available again to whatever program (e.g., program 1 110a, program 2 110b, etc.) needs to pop a value from the free list 104.

The example system 100 illustrates two programs 110a-110b using the free list 104. However, it should be appreciated that any number of programs may be implemented in association with the free list 104 and the buffers 114. When an entry 108a-108b is popped from the free list 104 by a program 110a-110b, a returned value X represents an index to a free buffer 114 in the array map. The pop and free operations are atomic, so that if two or more programs 110 attempt to pop an entry 108 at the exact same time, the programs 110 do not receive the same index value X to the buffers 114. For example, if program 1 110a and program 2 110b call pop at the exact same time to get a free buffer, program 1 110a may be indexed to buffer 0 via a first access procedure 112a and program 2 110b may be indexed to buffer N−1 via a second access procedure 112b. That is, both programs 110a-110b will not receive value 0 and both programs 110a-110b will not receive value N−1. Instead, each program 110 is provided exclusive access to a buffer based on the value that each program 110 receives from the free list 104. Pushing the values 0 and N−1 back to the free list 104 as free entries 116a-116b is also based on atomic operations to prevent corruption of the free list 104.

In non-atomic scenarios, two or more programs 110 can receive the exact same value from the free list 104 when the programs 110 call pop at the exact same time. For example, if program 1 110a and program 2 110b both call pop at the same time, both programs 110a-110b could receive value 0 in non-atomic scenarios. In atomic scenarios, the kernel evaluates concurrency to ensure that out of all the entries 108 on the free list 104, the pop operation will never allocate 106 the same value back to multiple programs.

In some examples, program 1 110a is executing on CPU 1 and program 2 110b is executing on CPU 2. However, both programs 110a-110b could call pop and run through the same code path at the exact same time. Linux kernels can implement atomic procedures (e.g., based on locks and buffers) to ensure that both programs 110a-110b do not ever concurrently receive the same index from the free list 104. Likewise, pushing free entries 116a-116b back onto the free list 104 is also an atomic operation, such that program 1 110a and program 2 110b do not ever concurrently push their values in a manner that corrupts the free list 104.

When the free list 104 and the allocate/free functions 106/116 in the example system 100 are not implemented, a per-CPU map may be used to allocate the buffer values to each CPU. However, since program 1 110a and program 2 110b can run on the same CPU, program 1 110a could be preempted by program 2 110b if program 2 110b calls the same buffer value 114. That is, if program 1 110a begins to execute based on buffer 0 and, before program 1 110a finishes executing, program 2 110b also begins to execute based on buffer 0, then program 1 110a would be preempted by program 2 110b from completing its execution. Accordingly, absent the free list 104 and the allocate/free functions 106/116 that allow atomic access to the entry values, program 1 110a and program 2 110b are able to access 112 the same buffer 114 at the same time.

Based on atomic procedures, program 1 110a and program 2 110b can retrieve a pointer to the buffer 114 at index X from the array map, where the index X is different for each of the pointers. Thus, each program 110 has exclusive access to a buffer value in the buffers throughout the respective runtimes of the programs 110. Freeing procedures are performed by the programs 110a-110b after the programs 110a-110b have completed their respective executions by pushing the indices back to the stack/queue of the free list 104 as free entries 116a-116b. Once the free entries 116a-116b are pushed back to the free list 104, the same or different program may pop the entries to be reused as buffer indexes again in the future.

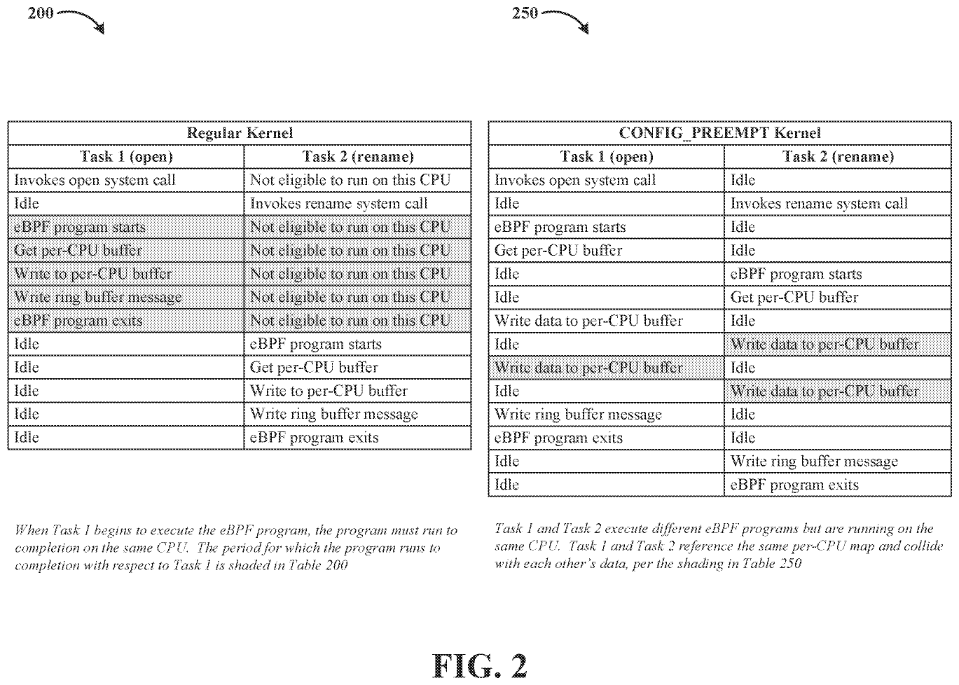

FIG. 2 illustrates tables 200-250 associated with kernel preemption being disabled and enabled. In particular, in table 200 for a regular kernel, when Task 1 begins to execute the eBPF program, preemption is disabled such that the eBPF program must run to completion on the same CPU. That is, all functionality from “eBPF program starts” to “eBPF program ends” for a given eBPF program is run to completion on the same CPU without being interrupted by another eBPF program on the same CPU. The period for which preemption is disabled with respect to Task 1 (e.g., where Task 2 is not eligible to run on the same CPU as Task 1) is illustrated by the shading in table 200.

In table 250 for a CONFIG_PREEMPT kernel, Task 1 and Task 2 execute different eBPF programs but are running on the same CPU. Task 1 and Task 2 reference the same per-CPU map and may collide with each other's data, per the shaded regions of table 250. That is, in a CONFIG_PREEMPT kernel, a first eBPF program may start running on a given CPU (e.g., “eBPF program starts”) but then get preempted by a second eBPF program that begins to run on the same CPU as the first eBPF program, causing the first eBPF program to not run to completion on the CPU without being interrupted by the second eBPF program.

A reason that per-CPU maps are suitable for eBPF programs associated with the legacy/regular kernel table 200 is due to a guarantee that for most types of programs a given eBPF program would run to completion on the CPU on which the program started. For example, if the program started on CPU X, the program runs to completion on CPU X. As a result, if data needs to be used during the runtime of the program, per-CPU data associated with CPU X is the only data that would be present for the entire run duration of the program. No other program would use the data based on the data being guaranteed to stay on CPU X and also due to no other program being allowed to use CPU X during the runtime of the program. Such techniques may be suitable with respect to the legacy/regular table 200 because kernel preemption is disabled during eBPF program execution in older types of Linux kernels.

In Linux kernels associated with the table 250 for a CONFIG_PREEMPT kernel, the guarantee of a program running to completion on CPU X with exclusive access to CPU X is no longer true. Thus, per-CPU maps are not an available option with respect to the table 250 to accomplish the same result as attained with respect to the table 200. For example, CONFIG_PREEMPT kernels may include a sequence where the eBPF program starts for eBPF program 1 and eBPF program 1 gets the per-CPU buffer. However, before eBPF program 1 writes data to the per-CPU buffer, a eBPF program starts for eBPF program 2 and eBPF program 2 gets the same per-CPU buffer as eBPF program 1. When eBPF program 2 later writes to the same per-CPU buffer as eBPF program 1 has already written to, it interferes with the data written to the per-CPU buffer by eBPF program 1. Afterwards, when eBPF program 1 writes a ring buffer message, eBPF program 1 would be using corrupted data before the eBPF program exits for eBPF program 1. eBPF program 2 may also use the corrupted data to write the ring buffer message for eBPF program 2 before the eBPF program exits for eBPF program 2. Hence, there needs to be another technique for guaranteeing that there is data that no other eBPF programs can interfere with and/or corrupt during the runtime of a given eBPF program.

Both tables 200-250 provide a guarantee that a given eBPF program instance will run to completion on the same CPU. That is, the eBPF program instance will not switch to a different CPU in between eBPF program start and eBPF program exit for the given eBPF program instance. However, in contrast to the table 200, the execution of two eBPF program instances can be interleaved in the table 250. For eBPF program instances, the system can only call functionality that the kernel provides. As newer Linux kernel versions are released, there may be more or different functionality provided for the newer Linux kernel version(s). An eBPF memory allocator is an added functionality. However, some eBPF programs running on older Linux kernel versions do not have access to the newly added allocator. Accordingly, the pushing and popping of values from the free list offers an alternative solution, associated with the table 200.

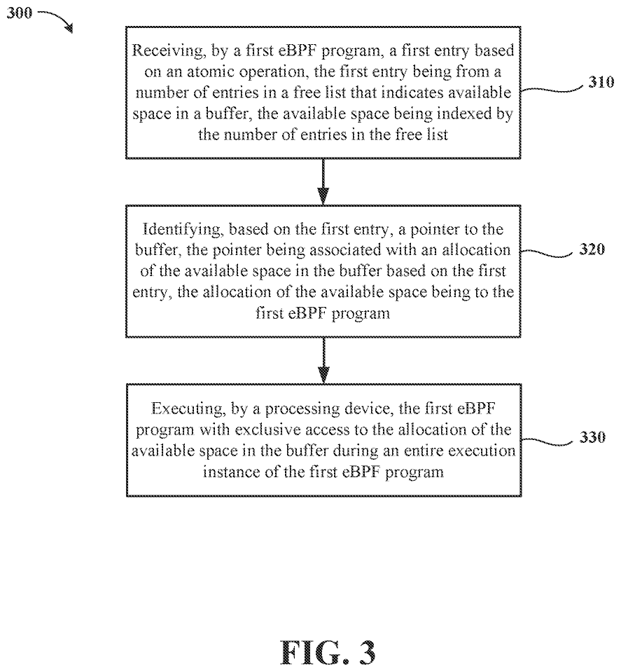

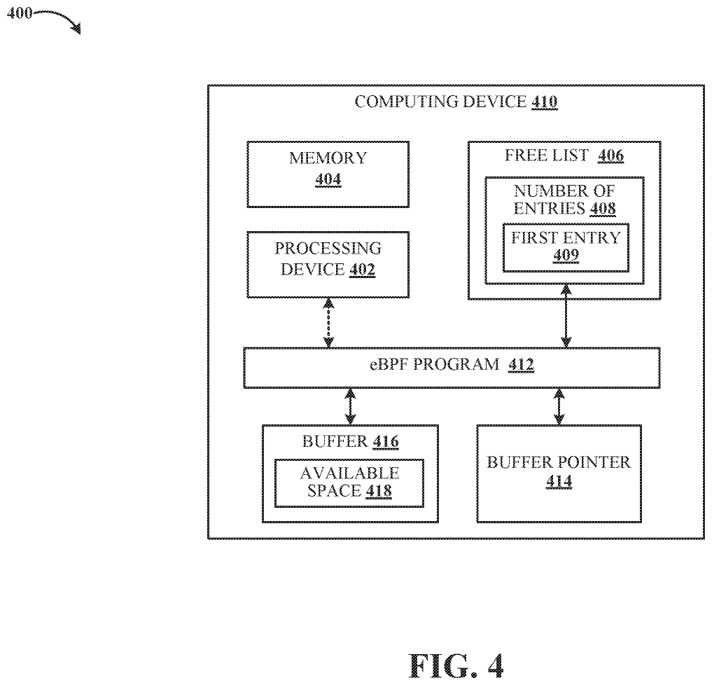

FIG. 3 is a flow diagram of a method 300 of dynamic memory allocation, in accordance with some embodiments of the present disclosure. A description of elements of FIG. 3 that have been previously described will be omitted for brevity. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 300 may be performed by processing device 402 shown in FIG. 4.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 have to be performed.

With reference to FIG. 3, method 300 begins at block 310, whereupon processing logic is receiving, by a first eBPF program, a first entry based on an atomic operation, the first entry being from a number of entries in a free list that indicates available space in a buffer, the available space being indexed by the number of entries in the free list. In some embodiments, the first eBPF program is similar to program 1 110a described herein with respect to FIG. 1. In some embodiments, the first entry is similar to the first entry 108a described herein with respect to FIG. 1. In some embodiments, the free list is similar to the free list 104 described herein with respect to FIG. 1. In some embodiments, the buffer is similar to the buffer 114 descried herein with respect to FIG. 1.

At block 320, the processing logic is identifying, based on the first entry, a pointer to the buffer, the pointer being associated with an allocation of the available space in the buffer based on the first entry, the allocation of the available space being to the first eBPF program. In some embodiments, the pointer to the buffer is similar to the access link 112a described herein with respect to FIG. 1. In some embodiments, the available space in the buffer is similar to buffer 0 described herein with respect to FIG. 1.

At block 330, the processing logic is executing, by a processing device, the first eBPF program with exclusive access to the allocation of the available space in the buffer during an entire execution instance of the first eBPF program. In some embodiments, the exclusive access to the allocation of the available space in the buffer is similar to the access 112a of buffer 0 during the execution of program 1 110a as described herein with respect to FIG. 1.

FIG. 4 is a component diagram of an example of a device architecture 400 for an eBPF general memory allocator, in accordance with embodiments of the disclosure. The device architecture 400 includes a computing device 410 having a processing device 402 and memory 404, which may implement the aspects described herein with respect to FIGS. 1 to 3.

Referring to FIG. 4, the computing device 410 may receive, by an eBPF program 412, a first entry 409 based on an atomic operation. In some embodiments, the eBPF program 412 is similar to program 1 110a described herein with respect to FIG. 1. In some embodiments, the first entry 409 is similar to the first entry 108a described herein with respect to FIG. 1.

The first entry 409 is from a number of entries 408 in a free list 406 that indicates available space 418 in a buffer 416. In some embodiments, the free list 406 is similar to the free list 104 described herein with respect to FIG. 1. The available space 418 is indexed by the number of entries in the free list 406. In some embodiment, the available space 418 is similar to buffer 0 described herein with respect to FIG. 1.

The eBPF program 412 running on the computing device 410 may identify, based on the first entry 409, a buffer pointer 414 to the buffer 416. In some embodiments, the buffer pointer 414 is similar to the access procedure 112a described herein with respect to FIG. 1. In some embodiments, the buffer 416 is similar to the buffer 114 described herein with respect to FIG. 1. The buffer pointer 414 is associated with an allocation of the available space 418 in the buffer 416 based on the first entry 409. The allocation of the available space 418 is to the eBPF program 412.

The computing device 410 may execute, by the processing device 402, the eBPF program 412 with exclusive access to the allocation of the available space 418 in the buffer 416 during an entire execution instance of the eBPF program 412. In some embodiments, the exclusive access to the allocation of the available space 418 in the buffer 416 is similar to the access 112a of buffer 0 during the execution of program 1 110a as described herein with respect to FIG. 1.

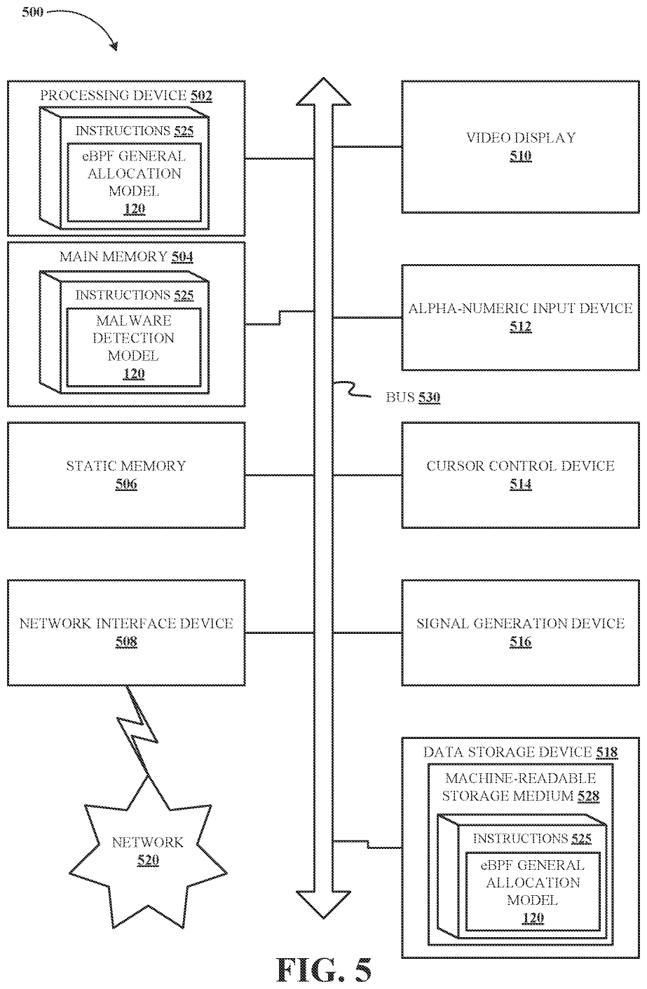

FIG. 5 is a block diagram of an example computing device 500 that may perform one or more of the operations described herein, in accordance with some embodiments of the disclosure. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 506 (e.g., flash memory) and a data storage device 518, which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may execute the operations described herein, in accordance with one or more aspects of the present disclosure, for performing the operations and steps discussed herein.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 525 that may include instructions for LLM operations, such as the eBPF general allocation model 120, for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “identifying,” “executing,” “releasing,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
receiving, by a first extended Berkeley packet filter (eBPF) program, a first entry based on an atomic operation, the first entry being from a number of entries in a free list that indicates available space in a buffer;
identifying, based on the first entry, a pointer to the buffer, the pointer being associated with an allocation of the available space in the buffer based on the first entry, the allocation of the available space being to the first eBPF program; and
executing, by a processing device, the first eBPF program with exclusive access to the allocation of the available space in the buffer during an execution instance of the first eBPF program.

2. The method of claim 1, further comprising:
releasing, based on the atomic operation, the first entry to the free list after completion of the execution instance of the first eBPF program, the first entry being available to a second eBPF program based on the releasing of the first entry by the first eBPF program.

3. The method of claim 2, further comprising:
receiving, by the second eBPF program, the first entry from the free list after the releasing of the first entry to the free list by the first eBPF program, the first entry being received by the second eBPF program based on the atomic operation.

4. The method of claim 1, wherein the allocation of the available space in the buffer is based on an eBPF map.

5. The method of claim 1, further comprising:
generating an array map and a stack map, the array map indicating a total number allocations of the buffer, the stack map indicating indices to the array map, wherein the first entry is associated with the stack map.

6. The method of claim 5, wherein the stack map is initialized to have a number of index values that is equal to the total number of allocations associated with the array map.

7. The method of claim 1, wherein the number of entries in the free list is pushed to the free list and popped from the free list using an atomic procedure.

8. The method of claim 1, wherein a second eBPF program that calls the free list executes on a same central processing unit (CPU) as the first eBPF program.

9. The method of claim 1, wherein kernel preemption is enabled during an execution instance of the first eBPF program.

10. A system comprising:
a processing device; and
a memory to store instructions that, when executed by the processing device cause the processing device to:
receive, by a first extended Berkeley packet filter (eBPF) program, a first entry based on an atomic operation, the first entry being from a number of entries in a free list that indicates available space in a buffer;
identify, based on the first entry, a pointer to the buffer, the pointer being associated with an allocation of the available space in the buffer based on the first entry, the allocation of the available space being to the first eBPF program; and
execute the first eBPF program with exclusive access to the allocation of the available space in the buffer during an execution instance of the first eBPF program.

11. The system of claim 10, wherein the processing device is further to:
release, based on the atomic operation, the first entry to the free list after completion of the execution instance of the first eBPF program, the first entry being available to a second eBPF program based on the release of the first entry by the first eBPF program.

12. The system of claim 11, wherein the processing device is further to:
receive, by the second eBPF program, the first entry from the free list after the release of the first entry to the free list by the first eBPF program, the first entry being received by the second eBPF program based on the atomic operation.

13. The system of claim 10, wherein the allocation of the available space in the buffer is based on an eBPF map.

14. The system of claim 10, wherein the processing device is further to:
generate an array map and a stack map, the array map indicates a total number allocations of the buffer, the stack map indicates indices to the array map, wherein the first entry is associated with the stack map.

15. The system of claim 14, wherein the stack map is initialized to have a number of index values that is equal to the total number of allocations associated with the array map.

16. The system of claim 10, wherein the number of entries in the free list is pushed to the free list and popped from the free list using an atomic procedure.

17. The system of claim 10, wherein a second eBPF program that calls the free list executes on a same central processing unit (CPU) as the first eBPF program.

18. The system of claim 10, wherein kernel preemption is enabled during an execution instance of the first eBPF program.

19. A non-transitory computer-readable storage medium including instructions that, when executed by a processing device, cause the processing device to:
receive, by a first extended Berkeley packet filter (eBPF) program, a first entry based on an atomic operation, the first entry being from a number of entries in a free list that indicates available space in a buffer;
identify, based on the first entry, a pointer to the buffer, the pointer being associated with an allocation of the available space in the buffer based on the first entry, the allocation of the available space being to the first eBPF program; and
execute, by the processing device, the first eBPF program with exclusive access to the allocation of the available space in the buffer during an execution instance of the first eBPF program.

20. The non-transitory computer-readable storage medium of claim 19, wherein the processing device is further to:
release, based on the atomic operation, the first entry to the free list after completion of the execution instance of the first eBPF program, the first entry being available to a second eBPF program based on the release of the first entry by the first eBPF program.
